(19) United States
(12) Patent Application Publication
(10) Pub. No.: US 2019/0309145 A1
(43) Pub. Date: Oct. 10, 2019

(54) RUBBER COMPOSITION FOR TIRE AND PNEUMATIC TIRE USING SAME

(71) Applicant: TOYO TIRE CORPORATION, Itami-shi, Hyogo (JP)

(72) Inventor: Haruka Kubo, Itami-shi (JP)

(73) Assignee: TOYO TIRE CORPORATION, Itami-shi, Hyogo (JP)

(21) Appl. No.: 16/348,613

(22) PCT Filed: Dec. 7, 2017
(86) PCT No.: PCT/JP2017/043968

§ 371 Date: May 9, 2019

(30) Foreign Application Priority Data
Dec. 15, 2016 (JP) 2016-243411

(51) Int. Cl. C08L 15/00; C08K 5/40; B60C 1/00

(52) U.S. Cl. CPC C08L 15/00; C08C 19/02; B60C 1/0016; C08K 5/40

(57) ABSTRACT

A rubber composition for a tire that can improve abrasion resistance while maintaining a vulcanization rate, and a pneumatic tire using the same, are disclosed. A rubber composition for a tire comprising 100 parts by mass of a rubber component containing a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, and 0.3 to 3 parts by mass of a thiuram type accelerator.

### TECHNICAL FIELD

The present invention relates to a rubber composition for a tire and a pneumatic tire using the same.

### BACKGROUND ART

As a method for improving abrasion resistance and the like of a rubber composition used in a pneumatic tire, Patent Documents 1 to 5 disclose using a hydrogenated copolymer having a hydrogenation ratio of a conjugated diene moiety of 75 mol % or more, obtained by copolymerizing aromatic vinyl and a conjugated diene compound.

### PRIOR ART DOCUMENTS

### Patent Document

Patent Document 1: JP-A-2016-56252

Patent Document 2: JP-A-2016-56349

Patent Document 3: JP-A-2016-56350

Patent Document 4: JP-A-2016-56351

Patent Document 5: JP-A-2016-69628

### SUMMARY OF THE INVENTION

### Problems that the Invention is to Solve

However, the hydrogenated copolymer having high hydrogenation ratio has small number of crosslinking points and therefore has the problem that vulcanization rate is slow.

In view of the above, the present invention has an object to provide a rubber composition for a tire that can improve abrasion resistance while maintaining a vulcanization rate, and a pneumatic tire using the same.

### Means for Solving the Problems

To solve the above-described problems, the rubber composition for a tire according to the present invention comprises 100 parts by mass of a rubber component containing a hydrogenated copolymer obtained by hydrogenation an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol or more, and 0.3 to 3 parts by mass of a thiuram type accelerator.

The rubber composition for a tire according to the present invention can further contain a sulfenamide type accelerator, and the content of the sulfenamide type accelerator can be 0.5 to 2.5 parts by mass per 1 part by mass of the thiuram type accelerator.

The rubber composition for a tire according to the present invention can be preferably used in a tread.

The pneumatic tire according to the present invention can be manufactured using the rubber composition for a tire.

### Effects of the Invention

According to the rubber composition for a tire of the present invention, a tire having further improved abrasion resistance can be obtained while maintaining or further improving a vulcanization rate.

### MODE FOR CARRYING OUT THE INVENTION

The items relating to the embodiment of the present invention are described in detail below.

The rubber composition according to this embodiment comprises 100 parts by mass of a rubber component containing a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, and 0.3 to 3 parts by mass or a thiuram type accelerator.

The rubber component used in the rubber composition according to this embodiment contains a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more. In the present description, the weight average molecular weight measured by gel permeation chromatography (GPC) is a value calculated in terms of polystyrene based on commercially available standard polystyrene, using a differential refractive index detector (RI) as a detector under the conditions that a solvent is tetrahydrofuran (THF), a measurement temperature is 40° C., a flow rate is 1.0 mL/min, a concentration is 1.0 g/L and an injection quantity is 40 μL. The hydrogenation ratio is a value calculated from a spectrum decrease rate of an unsaturated bond moiety of a spectrum obtained by measuring H¹-NMR

The aromatic vinyl constituting the aromatic vinyl-conjugated diene copolymer is not particularly limited, but examples thereof include styrene, α-methylstyrene, 1-vinylnaphthalene, 3-vinyltoluene, ethylvinylbenzene divinylbenzene, 4-cyclohexylstyrene and 2,4,6-trimethylstyrene. Those may be used alone or as a combination of two or more kinds.

The conjugated diene constituting the aromatic vinyl-conjugated diene copolymer is not particularly limited, but examples thereof include 1,3-butadiene, isoprene, 1,3-pentadiene, 2,3-dimethylbutadiene, 2-pheny-1,3-butadiene and 1,3-hexadiene. Those may be used alone or as a combination of two or more kinds.

The aromatic vinyl-conjugated diene copolymer is not particularly limited, but a copolymer of styrene and 1,3-butadiene (styrene-butadiene copolymer) is preferred. Therefore, the hydrogenated copolymer is preferably a hydrogenated styrene-butadiene copolymer. The hydrogenated copolymer may be a random copolymer, may be a block copolymer and may be an alternating copolymer. The aromatic vinyl-conjugated diene copolymer may be modified with at least one functional group selected from the group consisting of amino group, hydroxyl group, epoxy group, alkoxy group, alkylsilyl group, alkoxysilyl group and carboxyl group at a molecular end or in a molecular chain.

The hydrogenated copolymer can be synthesized by, for example, synthesizing an aromatic vinyl-conjugated diene copolymer and conducting a hydrogenation treatment. A method for synthesizing the aromatic vinyl-conjugated diene copolymer is not particularly limited, but the examples thereof include a solution polymerization method, a gas phase polymerization method and a bulk polymerization method, and a solution polymerization method is preferred. The polymerization form may be any of a batch type and a continuous type. The aromatic vinyl-conjugated diene copolymer can use the commercially available copolymers.

The hydrogenation method is not particularly limited, and the aromatic vinyl-conjugated diene copolymer is hydrogenated by the conventional method under the conventional conditions. The hydrogenation is generally conducted at 20 to 150° C. under a hydrogen pressure of 0.1 to 10 MPa in the presence of a hydrogenation catalyst. The hydrogenation ratio can be optionally adjusted by changing the amount of a hydrogenation catalyst, a hydrogen pressure when hydrogenating, a reaction time and the like. The hydrogenation catalyst can generally use a compound containing any of metals of Groups 4 to 11 of the periodic table. For example, a compound containing Ti, V, Co, Ni, Zr, Ru, Rh, Pd Hf, Re or Pt atom can be used as the hydrogenation catalyst. Examples of more specific hydrogenation catalysts include a metallocene compound such as Ti, Zr, Hf, Co, Ni, Pd, Pt, Ru, Rh or Re, a supported type heterogeneous catalyst comprising a carrier such as carbon, silica, alumina or diatomaceous earth and a metal such as Pd, Ni, Pt, Rh or Ru supported thereon a homogeneous Ziegler catalyst comprising a combination of an organic salt or acetylacetone salt of a metal element such as Ni or Co and a reducing agent such as organic aluminum an organic metal compound or complex of Ru or Rh; and fullerene or carbon nanotube having hydrogen occluded therein.

The hydrogenation ratio of the hydrogenated copolymer (proportion of hydrogenated moiety in conjugated moiety diene of aromatic vinyl-conjugated diene copolymer) is 80 mol or more and preferably 90 mol % or more. When the hydrogenation ratio is 80 mol % or more, the improvement effect of reinforcing strength and abrasion resistance due to homogenization of crosslinking is excellent.

The weight average molecular weight of the hydrogenated copolymer is not particularly limited so long as it is 300,000 or more. The weight average molecular weight is preferably 300.000 to 2,000,000, more preferably 300,000 to 1,000,000 and still more preferably 300,000 to 600,000.

The rubber component may contain a diene rubber other than the hydrogenated copolymer, and examples of the diene rubber include natural rubber (NR), isoprene rubber (IR), butadiene rubber (BR), styrene-butadiene rubber (SBR), styrene-isoprene copolymer rubber, butadiene-isoprene copolymer rubber and styrene-isoprene-butadiene copolymer rubber. Those diene rubbers can be used in one kind alone or as a blend of two or more kinds.

The content ratio of the hydrogenated copolymer in the rubber component is not particularly limited, but, is preferably 80 to 100 mass % and more preferably 90 to 100 mass %. When the content ratio is 80 mass % or more, the improvement effect of abrasion resistance is excellent.

The rubber composition according to this embodiment contains a thiuram type accelerator as a vulcanization accelerator.

The thiuram type accelerator is not particularly limited, but examples thereof include tetrabenzyl thiuram disulfide (TBzTD), tetramethyl thiuram monosulfide (TMTM), tetramethyl thiuram disulfide (TMTD), tetraethyl thiuram disulfide (TETD), tetrabutyl thiuram disulfide (TBTD), tetrakis(2-ethylhexyl)thiuram disulfide, dipentamethylene thiuram tetrasulfide (DPTT) and dipentamethylene thiuram hexasulfide. Those can be used in one kind alone or as a combination of two or more kinds.

The content of the thiuram type accelerator (total amount when using two or more kinds) is 0.3 to 3 parts by mass per 100 parts by mass of the rubber component. From the standpoint of the balance between a vulcanization rate and abrasion resistance, the content is preferably 0.5 to 3 parts by mass and more preferably 1 to 2 parts by mass. When the content is 0.3 parts by mass or more, the improvement effect of a vulcanization rate that is deteriorated when using the hydrogenated copolymer is excellent. When the content is 3 parts by mass or less, scorch is not generated.

Although not particularly limited, the rubber composition according to this embodiment preferably further contains a sulfenamide type accelerator as a vulcanization accelerator.

The sulfenamide type accelerator is not particularly limited, but examples thereof include N-cyclohexyl-2-benzothiazolyl sulfenamide (CBS), N-tert-butyl-2-benzothiazolyl sulfenamide (BBS), N,N-dicyclohexyl-2-benzothiazolyl sulfenamide (DCBS), N-oxydiethylene-2-benzothiazolyl sulfenamide (OBS), N,N-diisopropyl-2-benzothiazolyl sulfenamide (DPBS), N,N-di(2-ethylhexyl)-2-benzothiazolyl sulfenamide and N N-di(2-methylhexyl)-2-benzothiazolyl sulfenamide. Those can be used alone or as a combination of two or more kinds.

The content of the sulfenamide type accelerator (total amount when using two or more kinds) is not particularly limited, but the content is preferably 0.5 to 2.5 parts by mass, more preferably 0.5 to 2 parts by mass and still more preferably 0.5 to 1.5 parts by mass, per 1 part by mass of the thiuram type accelerator.

In the rubber composition according to this embodiment, carbon black and/or silica are preferably used as a reinforcing filler. In other words, the reinforcing filler may be carbon black alone, may be silica alone and may be a combination of carbon black and silica. A combination of carbon black and silica is preferably used. The content of the reinforcing filler is not particularly limited, and is, for example, preferably 10 to 150 parts by mass and more preferably 20 to 120 parts by mass, per 100 parts by mass of the rubber component.

The carbon black is not particularly limited and conventional various kinds can be used. The content of the carbon black is preferably 1 to 150 parts by mass and more preferably 1 to 70 parts by mass, per 100 parts by mass of the rubber component.

The silica is not particularly limited, but wet silica such as wet precipitated silica or wet gelled silica is preferably used. When the silica is contained, its content is preferably 10 to 150 parts by mass and more preferably 20 to 120 parts by mass, per 100 parts by mass of the rubber component from the standpoints of balance of tan δ of rubber, reinforcing properties and the like.

When the silica is contained, a silane coupling agent such as sulfide silane or mercaptosilane may be further contained. When the silane coupling agent is contained, its content is preferably 2 to 20 mass % based on the silica content.

In addition to the above components, compounding ingredients used in general rubber industries, such as a process oil, zinc flower, stearic acid, a softener, a plasticizer, a wax, an age resister, a vulcanizing agent and a vulcanization accelerator other than the above can be appropriately added in the general range to the rubber composition according to this embodiment.

Examples of the vulcanizing agent include sulfur components such as powdered sulfur, precipitated sulfur, colloidal sulfur, insoluble sulfur and highly dispersible sulfur. Although not particularly limited, the content of the vulcanizing agent is preferably 0.1 to 10 parts by mass and more preferably 0.5 to 5 parts by mass, per 100 parts by mass of the rubber component. The content of the vulcanization accelerator (total content when using a vulcanization accelerator other than the thiuram type accelerator) is preferably 0.1 to 7 parts by mass and more preferably 0.5 to 5 parts by mass, per 100 parts by mass of the rubber component.

The rubber composition according to this embodiment can be produced by kneading the necessary components according to the conventional method using a mixing machine generally used, such as Banbury mixer, a kneader or rolls. Specifically, additives excluding a vulcanizing agent and a vulcanization accelerator are added to the rubber component followed by mixing, in a first mixing step, and a vulcanizing agent and a vulcanization accelerator are added to the mixture obtained, followed by mixing, in a final mixing step. Thus, a rubber composition can be prepared.

Although not particularly limited, the rubber composition thus obtained is preferably used in a tread rubber constituting a ground-contact surface of a tire. For example, the rubber composition is extrusion-molded into a predetermined cross-sectional shape corresponding to a tread part. Alternatively, a ribbon-shaped rubber strip comprising the rubber composition is spirally wound on a drum to form a cross-sectional shape corresponding to a tread part. Thus, an unvulcanized tread rubber member is obtained. The tread rubber member is fabricated into a tire shape together with other tire members constituting a tire, such as an inner liner, a carcass, a belt, a bead core, a bead filler and a sidewall, according to the conventional method. Thus, a green tire (unvulcanized tire) is obtained. The green tire thus obtained is vulcanization-molded at, for example, 140 to 180° C. according to the conventional method. Thus, a pneumatic tire is obtained.

The kind of the pneumatic tire according to this embodiment is not particularly limited, and examples of the pneumatic tire include various tires such as tires for passenger cars and heavy load tires for trucks, buses and the like.

### EXAMPLES

Examples of the present invention are described below, but the present invention is not construed as being limited to those examples.

### Synthesis Example 1 of Hydrogenated Copolymer

2.5 L of cyclohexane, 50 g of tetrahydrofuran, 0.12 g of n-butyl lithium, 100 g of styrene and 400 g of 1,3-butadiene were put in a nitrogen-substituted heat-resistant reactor, and polymerization was conducted at a reaction temperature of 50° C. After completion of the polymerization, 1.7 g of N,N-bis(trimethylsilyl)aminopropylmethyl diethoxysilane was added, a reaction was conducted for 1 hour and hydrogen gas was then supplied under a pressure of 0.4 MPa-gauge. The reaction was conducted at a reaction temperature of 90° C. under a hydrogen gas supply pressure of 0.7 MPa-gauge using a catalyst mainly comprising titanocene dichloride until reaching a target hydrogenation ratio. Solvent was removed to obtain hydrogenated copolymer 1.

The hydrogenated copolymer obtained had a weight average molecular weight by GPC of 350,000 in terms of polystyrene based on standard polystyrene. The measurement was conducted using “LC-10A” manufactured by Shimadzu Corporation as a measuring instrument using “PLgel-MIXED-C” manufactured by Polymer Laboratories as a column, using a differential refractive index detector (RI) as a detector and using THF as a solvent under the conditions that a measurement temperature is 40° C., a flow rate is 1.0 mL/min, a concentration is 1.0 g/L and an injection amount is 40 μL. The amount of bonded styrene was 20 mass % and the hydrogenation ratio of the butadiene moiety was 90 mol %. The amount of the bonded styrene was obtained from a spectrum intensity ratio of proton based on styrene unit and proton based on butadiene unit (containing hydrogenated portion) using H¹-NMR.

### Synthesis Example 2 of Hydrogenated Copolymer

Hydrogenated copolymer 2 was obtained by the same method as Synthesis Example 1, except for changing the reaction time for hydrogenation and changing the target hydrogenation ratio. The hydrogenated copolymer 2 obtained had a weight average molecular weight of 350,000 in terms of polystyrene based on standard polystyrene. The amount of bonded styrene was 20 mass % and the hydrogenation ratio of the butadiene moiety was 80 mol %.

### Examples and Comparative Examples

Using a Banbury mixer, components excluding a vulcanization accelerator and sulfur were added according to the formulations (parts by mass) shown in Table 1 below, followed by mixing, in a first mixing step (non-processing kneading step) (discharge temperature: 160° C.). A vulcanization accelerator and sulfur were added to the mixture obtained, followed by mixing, in a final mixing step (processing kneading step) (discharge temperature: 90° C.). Thus, a rubber composition was prepared.

The details of each component in Table 1 are as follows.

SBR: “HPR350” manufactured by JSR Corporation

Hydrogenated SBR 1: Hydrogenated copolymer 1 prepared according to Synthesis Example 1

Hydrogenated SBR 2: Hydrogenated copolymer 2 prepared according to Synthesis Example 2

Silica: “Ultrasil VN3” manufactured by Evonik

Carbon black: “SEAST 3” manufactured by Tokai Carbon Co., Ltd.

Oil: “PROCESS NC140” manufactured by JX Nippon Oil & Sun Energy Corporation

Zinc flower: “Zinc Flower #3” manufactured by Mitsui Mining & Smelting Co., Ltd

Stearic acid: “LUNAC S-20” manufactured by Kao Corporation

Age resister: “NOCRAC 6C” manufactured by Ouchi Shinko Chemical Industrial Co., Ltd.

Wax: “OZOACE 0355” manufactured by Nippon Seiro Co., Ltd.

Silane coupling agent: “Si69” manufactured by Evonik

Sulfur: “Powdered Sulfur” manufactured by Tsurumi Chemical Industry Co., Ltd

Vulcanization accelerator 1: Sulfenamide type accelerator, “SOXINOL CZ” manufactured by Sumitomo Chemical Co., Ltd.

Vulcanization accelerator 2: Guanidine type accelerator, “NOCCELER D” manufactured by Ouchi Shinko Chemical Industrial Co., Ltd

Vulcanization accelerator 3: Thiuram type accelerator, “ACCEL TBZT” manufactured by Kawaguchi Chemical Industry Co., Ltd.

Vulcanization accelerator 4: Thiuram type accelerator. “SANCELLER TT” manufactured by Sanshin Chemical Industry Co., Ltd

Vulcanization accelerator 5: Thiuram type accelerator, “SANCELLER TS” manufactured by Sanshin Chemical Industry Co., Ltd.

Vulcanization rate and abrasion resistance of each composition obtained were evaluated. The evaluation methods are as follows.

Vulcanization rate: Vulcanization curve of a rubber composition was measured at 160° C. according to JIS K6300-2. The maximum value (Fmax) and the minimum value (Fmin) of torque in the vulcanization curve were measured, and the time (min) until reaching the torque of {(Fmax−Fmin)×0.9+Fmin} was defined as 90% vulcanization time t90. The vulcanization rate was indicated by an index as the value of Comparative Example 1 being 100. The vulcanization rate is slow as the index is large.

Abrasion resistance: Measured using a test piece having a predetermined shape obtained by vulcanizing the rubber composition obtained at 160° C. for 30 minutes according to JIS K6264. Specifically, abrasion amount was measured under the conditions of load 40N, slip ratio: 30% and temperature: 23° C. using Lambourn abrasion tester manufactured by Iwamoto Seisaku-Sho. The reverse number of the abrasion amount is indicated by an index as the value of Comparative Example 1 being 100. Larger value shows small abrasion amount and excellent abrasion resistance.

TABLE 1

| | Com. | Com. | Com. | | | | | | | | | |
|---|---|---|---|---|---|---|---|---|---|---|---|---|
| | Ex. 1 | Ex. 2 | Ex. 3 | Ex. 1 | Ex. 2 | Ex. 3 | Ex. 4 | Ex. 5 | Ex. 6 | Ex. 7 | Ex. 8 | Ex. 9 |
| SBR | 100 | 100 | — | — | — | — | — | — | — | — | — | — |
| Hydrogenated SBR 1 | — | — | 100 | 100 | 100 | 100 | 100 | 100 | 100 | 100 | 100 | — |
| Hydrogenated SBR 2 | — | — | — | — | — | — | — | — | — | — | — | 100 |
| Silica | 60 | 60 | 60 | 60 | 60 | 60 | 60 | 60 | 60 | 60 | 60 | 60 |
| Carbon black | 5 | 5 | 5 | 5 | 5 | 5 | 5 | 5 | 5 | 5 | 5 | 5 |
| Oil | 10 | 10 | 10 | 10 | 10 | 10 | 10 | 10 | 10 | 10 | 10 | 10 |
| Zinc flower | 2 | 2 | 2 | 2 | 2 | 2 | 2 | 2 | 2 | 2 | 2 | 2 |
| Stearic acid | 2 | 2 | 2 | 2 | 2 | 2 | 2 | 2 | 2 | 2 | 2 | 2 |
| Age resister | 2 | 2 | 2 | 2 | 2 | 2 | 2 | 2 | 2 | 2 | 2 | 2 |
| Wax | 2 | 2 | 2 | 2 | 2 | 2 | 2 | 2 | 2 | 2 | 2 | 2 |
| Silane coupling agent | 5 | 5 | 5 | 5 | 5 | 5 | 5 | 5 | 5 | 5 | 5 | 5 |
| Sulfur | 2 | 2 | 2 | 2 | 2 | 1 | 1 | 1 | 2 | 2 | 2 | 2 |
| Vulcanization accelerator 1 | 1.5 | 1.5 | 1.5 | 1.5 | 1.5 | 1.5 | 1.5 | 0.5 | 1.5 | 1.5 | 1.5 | 1.5 |
| Vulcanization accelerator 2 | 2 | — | 2 | — | — | — | 2 | — | — | — | — | — |
| Vulcanization accelerator 3 | — | 2 | — | 2 | 1 | 1 | 1 | 1 | 0.5 | — | — | 2 |
| Vulcanization accelerator 4 | — | — | — | — | — | — | — | — | — | 2 | — | — |
| Vulcanization accelerator 5 | — | — | — | — | — | — | — | — | — | — | 2 | — |
| Vulcanization rate | 100 | 50 | 130 | 60 | 90 | 100 | 40 | 80 | 100 | 40 | 45 | 45 |
| Abrasion resistance | 100 | 100 | 100 | 120 | 120 | 150 | 140 | 140 | 140 | 120 | 120 | 135 |

The results are shown in Table 1. It is understood from the comparison between Comparative Example 1 and Comparative Example 3 that when the hydrogenated copolymer is contained, the vulcanization rate is decreased.

On the other hand, it is recognized from the comparison between Examples 1 to 9 and Comparative Example 1 that when the hydrogenated copolymer and the thiuram type accelerator are contained, the vulcanization rate is maintained or improved, and the abrasion resistance is improved.

### INDUSTRIAL APPLICABILITY

The rubber composition for a tire of the present invention can be used in various tires of passenger cars, light trucks, buses and the like.

1-4. (canceled)

5. A rubber composition for a tire comprising:
100 parts by mass of a rubber component containing a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, and
0.3 to 3 parts by mass of a thiuram type accelerator.

6. The rubber composition for a tire according to claim 5, further comprising a sulfenamide type accelerator in an amount of 0.5 to 2.5 parts by pass per 1 part by mass of the thiuram type accelerator.

7. The rubber composition for a tire according to claim 5, which is for use in a tread.

8. The rubber composition for a tire according to claim 6, which is for use in a tread.

9. A pneumatic tire manufactured using the rubber composition for a tire according to claim 5.

10. A pneumatic tire manufactured using the rubber composition for a tire according to claim 6.

11. A pneumatic tire manufactured using the rubber composition for a tire according to claim 7.
